(19) United States
(12) Patent Application Publication
(10) Pub. No.: US 2016/0189413 A1
(43) Pub. Date: Jun. 30, 2016

(54) IMAGE CREATION METHOD, COMPUTER-READABLE STORAGE MEDIUM, AND IMAGE CREATION APPARATUS

(71) Applicant: CASIO COMPUTER CO., LTD., Tokyo (JP)

(72) Inventors: Yoshiharu Houjou, Tokyo (JP); Nobuhiro Aoki, Tokyo (JP); Takashi Umemura, Yamanashi (JP)

(21) Appl. No.: 14/972,747

(22) Filed: Dec. 17, 2015

(30) Foreign Application Priority Data
Dec. 26, 2014 (JP) 2014-266673

(51) Int. Cl. G06T 11/60; G06T 13/20; G06K 9/00

(52) U.S. Cl. CPC G06T 11/60; G06K 9/00248; G06K 9/00281; G06K 9/00288; G06T 13/20

(57) ABSTRACT

An image creation method executed by a control unit including the steps: extracting a plurality of specific portions in a facial region of a facial image created by photographing a face from a front; selecting a plurality of illustration part images, which is viewed from a different view point from the front, corresponding to the specific portions; and making a portrait image of the face viewed from the different view point from the front, based on the illustration part images selected in the step of selecting.

This application is based upon and claims the benefit of priority from the prior Japanese Patent Application No 2014-266673, filed Dec. 26, 2014, and the entire contents of which are incorporated herein by reference.

### BACKGROUND OF THE INVENTION

1. Field of the Invention

The present invention relates to an image creation method, a computer-readable storage medium, and an image creation apparatus.

2. Related Art

Conventionally, there has been a technology for creating a facial image from an image that photographs a face. For example, Japanese Unexamined Patent Application, Publication No. 2003-85576 discloses a technology for creating a facial image using a profile of each face part extracted from an image in which a face is photographed.

### SUMMARY OF THE INVENTION

However, with the abovementioned technology disclosed in Japanese Unexamined Patent Application, Publication No. 2003-85576, due to the facial image being created using a profile of each face part thus extracted, for example, if the facial image is a face from a front view, a facial image from a front view is created. For this reason, there is a problem in that a facial image thus created depends on a photographing direction of the face picture, and thus expressions of the facial image are limited.

The present invention was made by considering such a situation, and it is an object of the present invention to create an expressive facial image from an original image.

In order to achieve the abovementioned object, the present invention is an image creation method executed by a control unit, including the steps: extracting a plurality of specific portions in a facial region of a facial image created by photographing a face from a front; selecting a plurality of illustration part images, which is viewed from a different view point from the front, corresponding to the specific portions extracted from among a plurality of illustration part images in forms viewed in a different direction from the front; and making a portrait image of the face viewed from the different view point from the front, based on the illustration part images selected in the step of selecting.

### BRIEF DESCRIPTION OF THE DRAWINGS

FIG. 1 is a block diagram illustrating a hardware configuration of an image capture apparatus according to an embodiment of the present invention;

FIG. 2 is a schematic view for explaining a method of creating a facial image in the present embodiment;

FIG. 3 is a schematic view for explaining a method of creating a facial image in the present embodiment;

FIG. 4 is a schematic view for explaining a method of creating a facial image in the present embodiment;

FIG. 5 is a schematic view for explaining a method of creating a facial image in the present embodiment;

FIG. 6 is a functional block diagram showing a functional configuration for executing facial image creation processing, among the functional configurations of the image capture apparatus of FIG. 1; and

FIG. 7 is a flow chart for explaining a flow of facial image creation processing executed by the image capture apparatus of FIG. 1 having a functional configuration of FIG. 6.

### DETAILED DESCRIPTION OF THE INVENTION

Embodiments of the present invention are explained below with reference to the drawings.

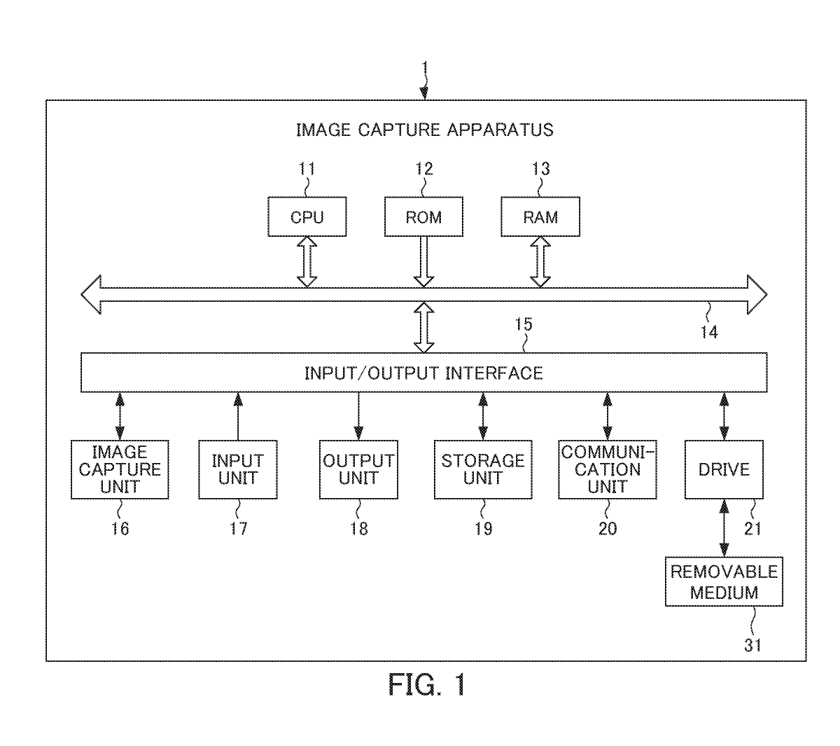

FIG. 1 is a block diagram illustrating the hardware configuration of an image capture apparatus according to an embodiment of the present invention.

The image capture apparatus 1 is configured as, for example, a digital camera.

The image capture apparatus 1 includes a CPU (Central Processing Unit) 11 which is an operation circuit, ROM (Read Only Memory) 12, RAM (Random Access Memory) 13, a bus 14, an input/output interface 15, an image capture unit 16, an input unit 17, an output unit 18, a storage unit 19, a communication unit 20, and a drive 21.

The CPU 11 executes various processing according to programs that are recorded in the ROM 12, or programs that are loaded from the storage unit 19 to the RAM 13.

The RAM 13 also stores data and the like necessary for the CPU 11 to execute the various processing, as appropriate.

The CPU 11, the ROM 12 and the RAM 13 are connected to one another via the bus 14. The input/output interface 15 is also connected to the bus 14. The image capture unit 16, the input unit 17, the output unit 18, the storage unit 19, the communication unit 20, and the drive 21 are connected to the input/output interface 15.

The image capture unit 16 includes an optical lens unit and an image sensor, which are not shown.

In order to photograph an object, the optical lens unit is configured by a lens such as a focus lens and a zoom lens for condensing light.

The focus lens is a lens for forming an image of an object on the light receiving surface of the image sensor. The zoom lens is a lens that causes the focal length to freely change in a certain range.

The optical lens unit also includes peripheral circuits to adjust setting parameters such as focus, exposure, white balance, and the like, as necessary.

The image sensor is configured by an optoelectronic conversion device, an AFE (Analog Front End), and the like.

The optoelectronic conversion device is configured by a CMOS (Complementary Metal Oxide Semiconductor) type of optoelectronic conversion device and the like, for example. Light incident through the optical lens unit forms an image of an object in the optoelectronic conversion device. The optoelectronic conversion device optoelectronically converts (i.e. captures) the image of the object, accumulates the resultant image signal for a predetermined time interval, and sequentially supplies the image signal as an analog signal to the AFE.

The AFE executes a variety of signal processing such as A/D (Analog/Digital) conversion processing of the analog signal. The variety of signal processing generates a digital signal that is output as an output signal from the image capture unit 16.

Such an output signal of the image capture unit 16 is hereinafter referred to as “data of a captured image”. Data of a captured image is supplied to the CPU 11, an image processing unit (not illustrated), and the like as appropriate.

The input unit 17 is configured by various buttons and the like, and inputs a variety of information in accordance with instruction operations by the user.

The output unit 18 is configured by the display unit, a speaker, and the like, and outputs images and sound.

The storage unit 19 is configured by DRAM (Dynamic Random Access Memory) or the like, and stores data of various images.

The communication unit 20 controls communication with other devices (not shown) via networks including the Internet.

A removable medium 31 composed of a magnetic disk, an optical disk, a magneto-optical disk, semiconductor memory or the like is installed in the drive 21, as appropriate. Programs that are read via the drive 21 from the removable medium 31 are installed in the storage unit 19, as necessary. Similarly to the storage unit 19, the removable medium 31 can also store a variety of data such as the image data stored in the storage unit 19.

The image capture apparatus 1 configured as above has a function that enables to create a facial image which is made into an animation character in a fashion in which the face is viewed in an oblique direction from an image in which a person's face is photographed from the front.

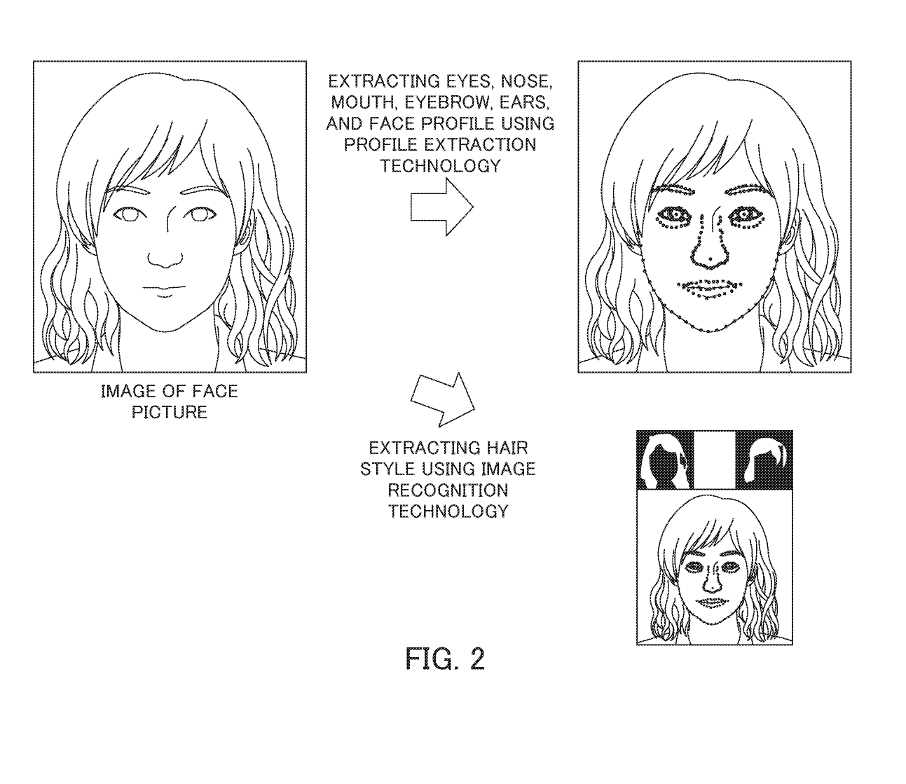

FIGS. 2 to 5 are schematic views for explaining a method of creating a facial image according to the present embodiment.

As illustrated in FIG. 2, the facial image in the present embodiment extracts portions constituting a face (in the present embodiment, specific portions such as profiles of eyes, nose, mouth, eyebrow, ears, face, and hair style) from an image in which a person's face is photographed from the front (herein after, referred to as “original image”), and which is a target for processing.

More specifically, for each portion of the face (in the present embodiment, specific portions such as profiles of eyes, nose, mouth, eyebrow, ears, face, and hair style), a profile of each portion is extracted using a profile extraction technology. In the present example, regarding the extraction of a profile, although the profile extraction technology that recognizes a characteristic of a form from the front (front form) by capturing each part of a face at a plurality of points is used, it is acceptable so long as each part of the face can be extracted, and thus it is possible to use existing image analysis technology.

Furthermore, in the present embodiment, an image recognition technology is used for extracting a hair style which is another portion. In the present example, for the extraction of the hair style, it is possible to use existing image analysis technology. It should be noted that the hair style may also be extracted using the profile extraction technology.

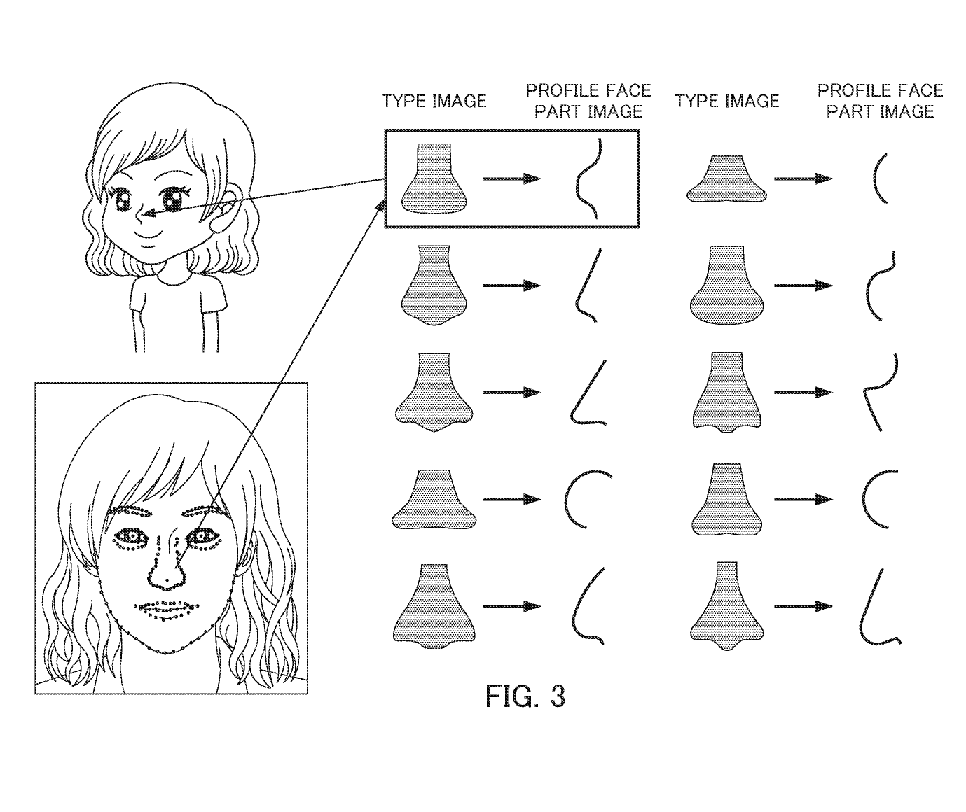

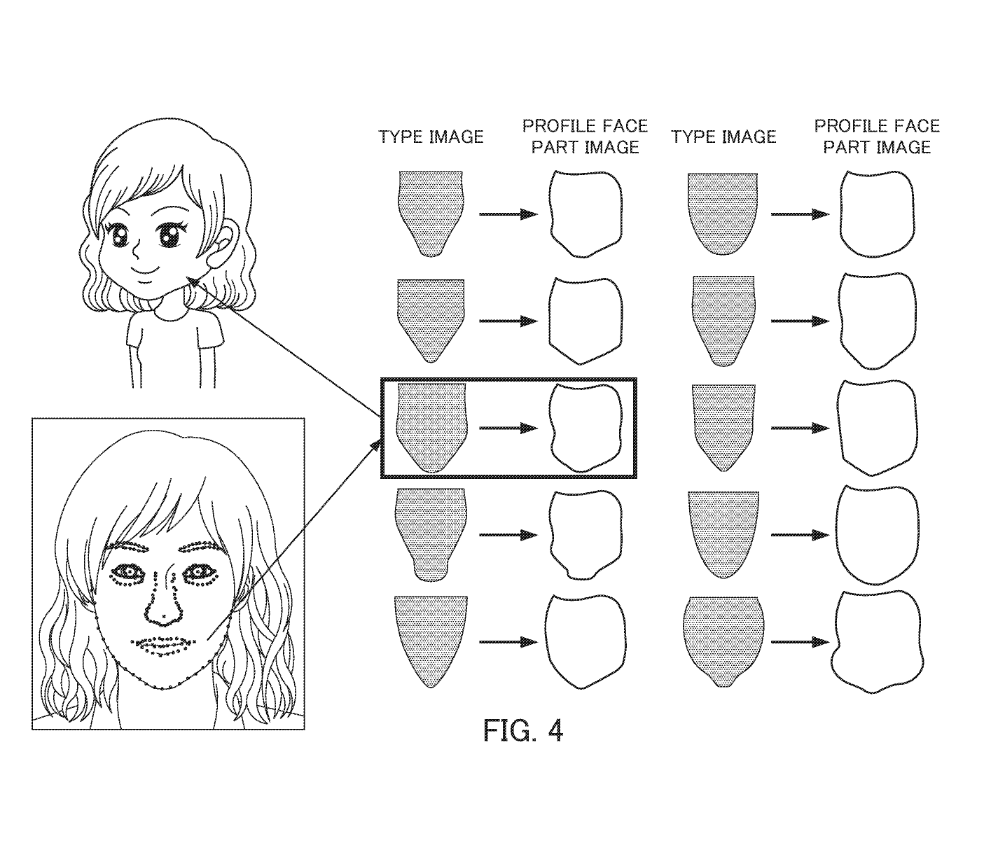

Next, as illustrated in FIGS. 3 and 4, a profile of each portion thus extracted is classified into types which are prepared by standardizing a plurality of each of face parts that are prepared for each portion. In the present embodiment, 10 types are provided, and the face part thus extracted is classified into any type thereamong.

More specifically, by matching the face part thus extracted with an image representing a type of a face part (hereinafter, referred to as “type image”), a matching type is decided. It should be noted that the type image is an image when seeing a face part from the front and thus an image in which a form in a case in which a type of a face part as viewed in a plane is viewed in an oblique direction is followed is made into animation character (illustration). Furthermore, the type image is associated with an image in which the face part thus extracted is made into animation character as viewed in an oblique direction (hereinafter, referred to as “profile face type image”). In other words, in a case of making an animation character image of a profile face from a face as viewed from the front, it is performed by classifying a face part viewed from the front, relaying a corresponding type image, and selecting a profile face type image of a face in profile assumed from the type image.

Next, each profile face part images (a plurality of part images in the form of illustration of which form is seen from a different view point from the front) corresponding to the type images corresponding to the type thus decided is acquired and used as face parts constituting a facial image.

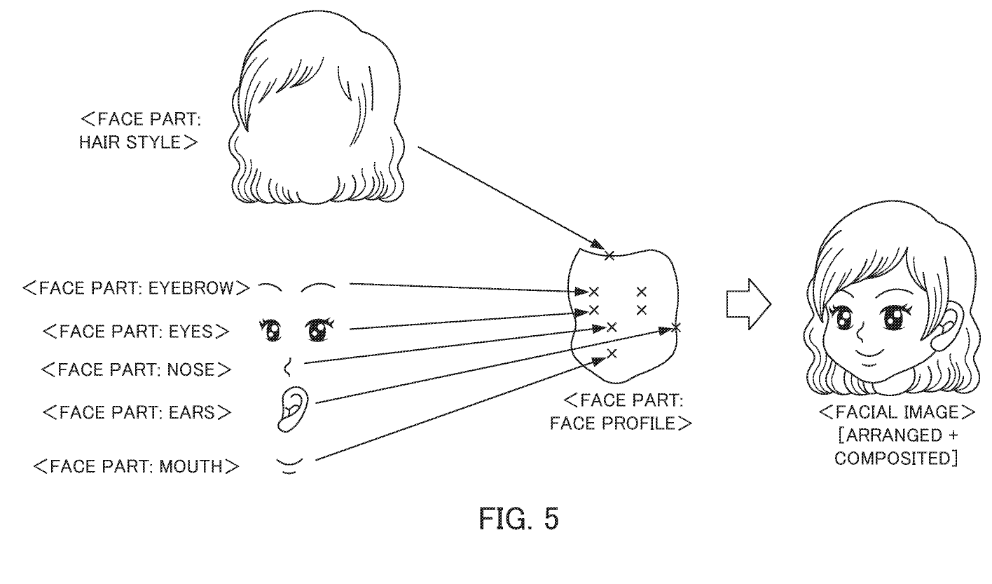

Thereafter, as illustrated in FIG. 5, a facial image is made by arranging and compositing the profile face parts thus acquired at appropriate positions to establish a face.

More specifically, in the present embodiment, a facial image (a portrait image of a face) is created by arranging other face parts at predetermined positions of a profile face part image of a face part of a face profile so as to composite into one image.

In other words, an arrangement reference point (denoted by an X-mark in the drawings), which is a reference of an arrangement of each profile face part image, is provided respectively in a profile face part image of a face profile which is a reference for the arrangement, and a corresponding arrangement point (not illustrated) is set also at each profile face part image. In a case of arranging other profile face part images with respect to the profile face part image of the face profile, positioning is performed by matching an arrangement point of other corresponding profile face part images on the arrangement reference point. Thereafter, it is possible to create a face image by compositing into one image at the position.

It should be noted that, in the present embodiment, as illustrated in FIGS. 2 to 5, the “profile face” refers to a face in a state of being viewed in a direction different from the direction viewed from the front, in a state of each portion of the face being viewable, and in a state of being viewed in an oblique direction (for example, in an obliquely right direction) so that a state of unevenness of each portion can be distinguished.

Therefore, since the facial image created according to the present embodiment is created by classifying face parts having various shapes extracted from the original image into a plurality of types and replacing with profile face type images having the shapes of the types as viewed in an oblique direction, it is possible to easily create a facial image as viewed in a direction different from the direction from the front (in an obliquely right direction in the present embodiment), and it is also possible to create a facial image which is similar to a case of a face being actually viewed in an oblique direction by employing a profile face part image assumed from shapes of predetermined types.

Therefore, since it is possible to create a facial image as viewed in a different direction even when employing an image photographed in a specific direction as an original image, it is possible to create an expressive facial image.

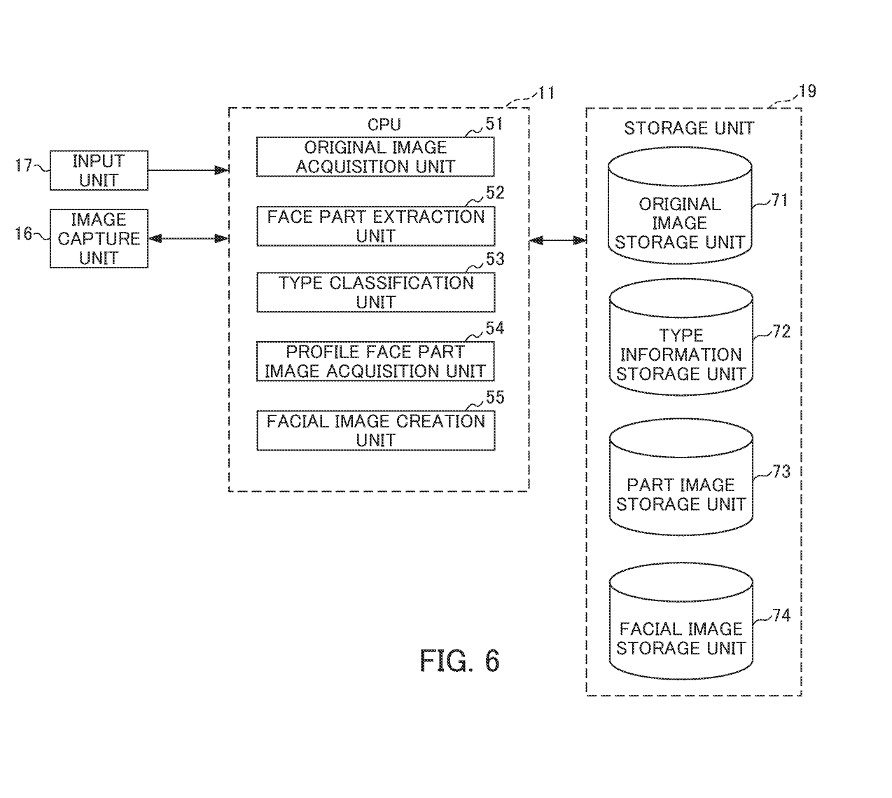

FIG. 6 is a functional block diagram showing a functional configuration for executing facial image creation processing, among the functional configurations of the image capture apparatus 1 of FIG. 1.

The facial image creation processing refers to a sequence of processing of classifying a profile of each portion of a face extracted from an original image including the face of a person photographed from the front and creating a facial image in a stereoscopic view from each of the face part images corresponding to types classified.

In a case of executing the facial image creation processing, as illustrated in FIG. 6, an original image acquisition unit 51, a face part extraction unit 52, a type classification unit 53, a profile face part image acquisition unit 54, and a facial image creation unit 55 function in the CPU 11.

Furthermore, an original image storage unit 71, a type information storage unit 72, a part image storage unit 73, and a facial image storage unit 74 are set in a region of the storage unit 19.

The original image storage unit 71 stores data of an image (original image as a target for processing), which was acquired externally from the image capture unit 16 or via the internet. In the present embodiment, data of actually-photographed (photographic) image in which the face of a person is photographed from the front is stored.

The type information storage unit 72 stores information in which type images for each portion are associated with face part images. More specifically, the type information storage unit 72 stores the corresponding relationship between the type images illustrated in FIGS. 3 and 4 and the profile face part images corresponding to the type images.

The part image storage unit 73 stores a plurality of type images for each portion and data of corresponding profile face part images. More specifically, in the part image storage unit 73, in the example of the face parts of a nose profile and a face profile, the type images illustrated in FIGS. 3 and 4 and the profile face part images corresponding to the type images are stored.

Furthermore, for each face part image, in order to arrange face part images, as illustrated in FIG. 5, the arrangement reference points are added and coordinate information of corresponding arrangement points in an image is added to other face parts.

In the facial image storage unit 74, data of the facial images thus created is stored. More specifically, the facial image storage unit 74 stores data of the facial images illustrated in FIG. 5.

The original image acquisition unit 51 acquires an original image as a target for creating a facial image stored in the original image storage unit 71 based on an operation of selecting an image via the input unit 17 by a user.

The face part extraction unit 52 analyzes the original image acquired by the original image acquisition unit 51 and specifies and extracts face parts (in the present embodiment, eyes, eyebrows, nose, mouth, ears, face profile, and hairstyle).

More specifically, as illustrated in FIG. 2, for eyes, eyebrows, nose, mouth, ears, and face profile, the face part extraction unit 52 uses a profile recognition technology, and for the hairstyle, an image recognition technology is used to specify a hairstyle and each face part is extracted.

The type classification unit 53 classifies each of the face parts extracted and decides their types.

More specifically, as illustrated in FIGS. 3 and 4, the type classification unit 53 compares a type image of a corresponding portion with an outer form of a face part based on the type information stored in the type information storage unit 72 so as to classify the type of the face part.

The profile face part image acquisition unit 54 acquires a profile face part image stored in the part image storage unit 73 based on a classification result.

More specifically, the profile face part image acquisition unit 54 refers to type information from the classification result and, as illustrated in FIGS. 3 and 4, acquires a profile face part image corresponding to the type image of the type classified.

The face image creation unit 55 arranges the face part of each portion acquired by the profile face part image acquisition unit 54 at a predetermined location and creates a face image.

More specifically, as illustrated in FIG. 5, the face image creation unit 55 matches arrangement points of other face parts on arrangement reference points in the profile face part images of the face profiles for arrangement, and composites each profile face part images at the arranged location so as to create a face image.

Thereafter, the face image creation unit 55 causes the face image thus created to be stored in the face image storage unit 74.

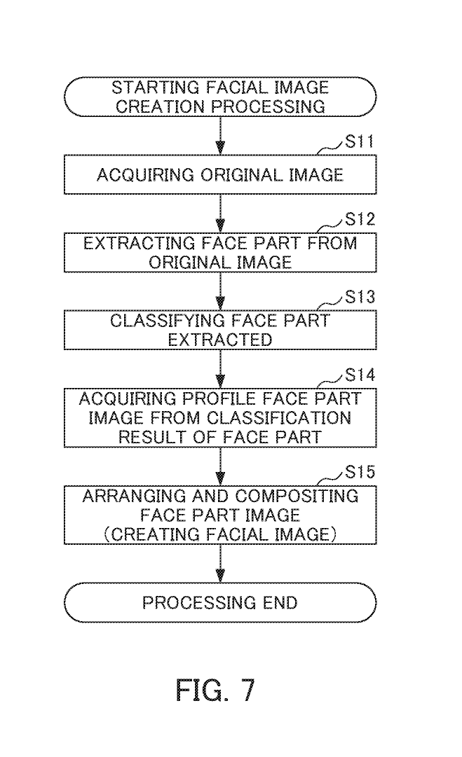

FIG. 7 is a flow chart for explaining a flow of facial image creation processing executed by the image capture apparatus 1 of FIG. 1 having a functional configuration of FIG. 6.

The face image creation processing starts by an operation of starting the face image creation processing on the input unit 17 by a user.

In Step S11, the original image acquisition unit 51 acquires an original image as a target for creating a face image from the original image storage unit 71 based on an operation of selecting an image via the input unit 17 by the user.

In Step S12, the face part extraction unit 52 analyzes a facial region of the original image thus acquired and extracts face parts (in the present embodiment, eyes, eyebrows, nose, mouth, ears, face profile, and hairstyle). More specifically, as illustrated in FIG. 2, for eyes, eyebrows, nose, mouth, ears, and face profile, the face part extraction unit 52 employs a profile recognition technology, and, for a hairstyle, an image recognition technology is used for specifying a hairstyle and each face part is extracted (step of extracting).

In Step S13, the type classification portion 53 classifies the face parts thus extracted into predetermined provided types. More specifically, as illustrated in FIGS. 3 and 4, the type classification unit 53 compares a type image of a corresponding portion with an outer form of a face part based on the type information stored in the type information storage unit 72 so as to classify a type of the face part. The type of the face part is classified by comparing between the face part thus extracted and a front form by viewing the image of the face part thus extracted from the front.

In Step S14, the profile face part image acquisition unit 54 acquires from the part image storage unit 73 a profile face part image corresponding to each of the type images from the classification result of the face part. More specifically, the profile face part image acquisition unit 54 refers to type information from the classification result and, as illustrated in FIGS. 3 and 4, acquires a profile face part image corresponding to the type image of the type classified (step of selecting). By comparing between the face part thus extracted and a front form by viewing the image of the face part thus extracted from the front, a profile face part image is selected based on the comparison result.

In Step S15, the face image creation unit 55 arranges and composites the profile face part image thus acquired so as to create a facial image. More specifically, as illustrated in FIG. 5, the face image creation unit 55 matches arrangement points of other face parts on arrangement reference points in the profile face part images of the face profiles for arrangement and composites each profile face part images at the arranged location so as to create a face image (the step of creating).

Then, the face image creation unit 55 causes data of the face image thus created to be stored in the face image storage unit 74.

Then, the face image creation processing ends. Therefore, based on image recognition, from an image of the face of a person from the front, an animation character image of a profile face is created based on an outer form recognition of each portion. However, since it is not possible to directly associate a portion (for example, nose) of which a profile is extracted from the front with a portion (for example, nose) of a profile face, an animation character image is created by using and associating a type image (image created by estimating a plane from the front when viewed from a lateral side) from the front corresponding to the profile face part depicted (for example, nose). Therefore, a face part from the front is extracted from an image photographed from the front conventionally, and a type image is used for the face part thus extracted, whereby it becomes possible to automatically create an expressive animation character image of a profile face.

The image capture apparatus 1 configured as above includes the part image storage unit 73, the face part extraction unit 52, the profile face part image acquisition unit 54 which is a profile face part image, and the face image creation unit 55.

The part image storage unit 73 makes a specific portion of a facial region (part portion of a face such as eyes and mouth) into a portrait, and a plurality of profile face part images which are part images in a view in which the specific portion is viewed from a different view from the front were stored.

The face part extraction unit 52 extracts a specific portion in a facial region of a facial image in which a face is photographed from the front.

The profile face part image acquisition unit 54 selects a profile face part image which is a part image that is adapted for a specific portion extracted from the face part extraction unit 52, from among the profile face part images which are a plurality of part images stored in the part image storage unit 73.

The face image creation unit 55 creates a facial image which is a portrait image in which a face viewed in a different view from the front is made into a portrait from a face in the face image based on the profile part image, which is a part image selected by the profile face part image acquisition unit 54.

With such a configuration, in the image capture apparatus 1, it is possible to easily create a facial image in a different direction from an image photographed in a specific direction. As a result, it is possible to create facial images which are various expressive portrait images.

For each of the profile face part images which are a plurality of part images, the part image storage unit 73 associates a profile face part image which is the part image with a front form viewed from the front, and stores the image.

The profile face part image acquisition unit 54 compares a specific portion extracted by the face part extraction unit 52 with the front form associated with each of the profile face part images, which are a plurality of part images stored in the part image storage unit 73, and selects a profile face part image which is a part image adapted for the specific portion extracted by the face part extraction unit 52.

With such a configuration, in the image capture apparatus 1, it is possible to easily create a facial image in a different direction from an image photographed in a specific direction. As a result, it is possible to create facial images which are various expressive portrait images.

As a specific portion, the face part extraction unit 52 takes a face as a plane, and makes the face into a line drawing so as to extract an outer form of a portion of the face.

The profile face part image acquisition unit 54 compares an outer form of a portion of a face with the front form associated with each of the profile face part images, which are a plurality of part images, and, based on the comparison result, selects the profile face part image which is a part image adapted for the specific portion extracted by the face part extraction unit 52.

With such a configuration, in the image capture apparatus 1, it is possible to easily create a facial image in a different direction from an image photographed in a specific direction. As a result, it is possible to create facial images which are various expressive portrait images.

The face image creation unit 55 composites the profile face part images, which are a plurality of part images thus selected, and creates a facial image which is a portrait image.

With such a configuration, in the image capture apparatus 1, it is possible to easily create a facial image in a different direction from an image photographed in a specific direction. As a result, it is possible to create facial images which are various expressive portrait images.

It should be noted that the present invention is not to be limited to the aforementioned embodiments, and that modifications, improvements, etc. within a scope that can achieve the objects of the present invention are also included in the present invention.

In the abovementioned embodiment, although it is configured so that the image in a different direction (in the present embodiment, in an obliquely right direction) from the face of a person photographed in a specific direction (in the present embodiment, the front) is created, the present invention is not limited thereto. For example, it may also be configured to create an image in a case of a subject being viewed in a different direction from the subject photographed in a specific direction.

Furthermore, although the predetermined stored profile face part images are used in the abovementioned embodiment, the present invention is not limited thereto and, for example, it may be configured to create the profile face part images each time a face part is extracted and classified into a type.

Furthermore, although the type is decided by comparing the outer form of the face part with the type image for classification, the present invention is not limited thereto and, for example, it may also be configured to provide a condition for each type and decide the type according to a degree of matching the condition.

In the aforementioned embodiments, explanations are provided with the example of the image capture apparatus 1 to which the present invention is applied being a digital camera; however, the present invention is not limited thereto in particular.

For example, the present invention can be applied to any electronic device in general having a facial image creation processing function. More specifically, for example, the present invention can be applied to a laptop personal computer, a printer, a television receiver, a video camera, a portable navigation device, a cell phone device, a smartphone, a portable gaming device, and the like.

The processing sequence described above can be executed by hardware, and can also be executed by software.

In other words, the hardware configurations of FIG. 6 are merely illustrative examples, and the present invention is not particularly limited thereto. More specifically, the types of functional blocks employed to realize the above-described functions are not particularly limited to the examples shown in FIG. 6, so long as the image capture apparatus 1 can be provided with the functions enabling the aforementioned processing sequence to be executed in its entirety.

A single functional block may be configured by a single piece of hardware, a single installation of software, or a combination thereof.

In a case in which the processing sequence is executed by software, the program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium containing such a program can not only be constituted by the removable medium 31 of FIG. 1 distributed separately from the device main body for supplying the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), Blu-ray (Registered Trademark) or the like. The magnetic optical disk is composed of an MD (Mini-Disk) or the like. The storage medium supplied to the user in a state incorporated in the device main body in advance is constituted by, for example, ROM in which the program is recorded or a hard disk, etc. included in the storage unit.

It should be noted that, in the present specification, the steps defining the program recorded in the storage medium include not only the processing executed in a time series following this order, but also processing executed in parallel or individually, which is not necessarily executed in a time series.

The embodiments of the present invention described above are only illustrative, and are not to limit the technical scope of the present invention. The present invention can assume various other embodiments. Additionally, it is possible to make various modifications thereto such as omissions or replacements within a scope not departing from the spirit of the present invention. These embodiments or modifications thereof are within the scope and the spirit of the invention described in the present specification, and within the scope of the invention recited in the claims and equivalents thereof.

What is claimed is:

1. An image creation method executed by a control unit, comprising the steps:
extracting a plurality of specific portions in a facial region of a facial image created by photographing a face from a front;
selecting a plurality of illustration part images, which is viewed from a different view point from the front, corresponding to the specific portions; and
making a portrait image of the face viewed from the different view point from the front, based on the illustration part images selected in the step of selecting.

2. The image creation method according to claim 1,
wherein the step of selecting compares between the specific portions extracted and front forms in which the part images are viewed from the front which are associated with each of the plurality of illustration part images and, based on a comparison result, selects an illustration part image suited for the specific portions extracted.

3. The image creation method according to claim 2,
wherein the step of extracting takes a face, as the specific portions, as a plane, makes the face into a line drawing and extracts a plurality of outer form of portions of the face, and
the step of selecting compares between the outer form of the portions of the face and the front forms associated with each of the plurality of illustration part images and, based on a comparison result, selects the illustration part images suited for the specific portions extracted by the extracting.

4. The image creation method according to claim 1,
wherein the step of creating composites the illustration part images selected to make the portrait image of the face.

5. The image creation method according to claim 1,
wherein, for a part image corresponding to a face profile among the illustration part images, a reference position at which to arrange an illustration part image other than the parts image corresponding to the face profile is set.

6. The image creation method according to claim 5,
wherein the step of creating arranges the part images other than a part image corresponding to the face profile based on the reference position of the illustration part image corresponding to the face profile to create a portrait image of the face.

7. The image creation method according to claim 1,
further comprising a step of creating the illustration part images from a face image created by photographing the face from the front.

8. A computer-readable storage medium that controls an image creation apparatus including a control unit to perform the following processing of:
extracting a plurality of specific portions in a facial region of a facial image created by photographing a face from a front;
selecting a plurality of illustration part images, which is viewed from a different view point from the front, corresponding to the specific portions; and
making a portrait image of the face viewed from the different view point from the front, based on the illustration part images selected in the step of selecting.

9. An image creation apparatus including a control unit to perform an image creation method comprising the step of:
extracting a plurality of specific portions in a facial region of a facial image created by photographing a face from a front;
selecting a plurality of illustration part images, which is viewed from a different view point from the front, corresponding to the specific portions; and
making a portrait image of the face viewed from the different view point from the front, based on the illustration part images selected in the step of selecting.

10. The image creation apparatus according to claim 9,
further including a storage unit that stores the illustration part images which are made by making specific portions of the facial region into portraits and in which the specific portions are viewed in a different view point from a front.

11. The image creation apparatus according to claim 9,
wherein the storage unit further stores by associating each of the illustration part images with front forms in which the illustration part images are viewed from the front.

12. The image creation apparatus according to claim 8,
wherein one or more of the storage unit is provided.
